(19) United States
(12) Patent Application Publication
(10) Pub. No.: US 2016/0041314 A1
(43) Pub. Date: Feb. 11, 2016

(54) ANTI-GLARE COVER FOR DISPLAY SCREEN

(71) Applicant: HON HAI PRECISION INDUSTRY CO., LTD., New Taipei (TW)

(72) Inventors: JEN-TSORNG CHANG, New Taipei (TW); SEI-PING LOUH, New Taipei (TW)

(21) Appl. No.: 14/451,785

(22) Filed: Aug. 5, 2014

(51) Int. Cl. G02B 5/02

(52) U.S. Cl. CPC G02B 5/0294; G02B 5/0231

(57) ABSTRACT

An anti-glare cover for a display screen viewable by a user is disclosed herein. The anti-glare cover has a substantially transparent film with a substantially flat first surface and a second surface having multiple indentations with a first angled surface and a second angled surface. The multiple indentations are arranged in substantially parallel vertical rows. The film is positionable over the display screen with the first film surface facing the display screen and the second film surface facing the user so that when the display screen is viewed by the user the first angled surface reflects incident light from a light source away from the user and towards the light source.

### FIELD

The subject disclosure relates to an anti-glare cover for a display screen cover. More specifically, an anti-glare display cover having angular prism microstructures thereon.

### BACKGROUND

An operator who wears far sighted or bifocal eye glasses or lenses needs to look upward to view a display screen which is vertically placed on a table top. On the other hand, if the display screen is tilted towards the overhead light sources, the screen can reflect the overhead light such that the operator can be blinded with the glare.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an illustration of an anti-glare display screen according to an example embodiment of the subject disclosure.

FIG. 2 is a cross-sectional illustration of an anti-glare display screen panel according to an example embodiment of the subject disclosure

FIG. 3 is a diagrammatic illustration of an anti-glare cover according to an example embodiment of the subject disclosure.

FIG. 4 is a diagrammatic illustration of an anti-glare cover according to another example embodiment of the subject disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

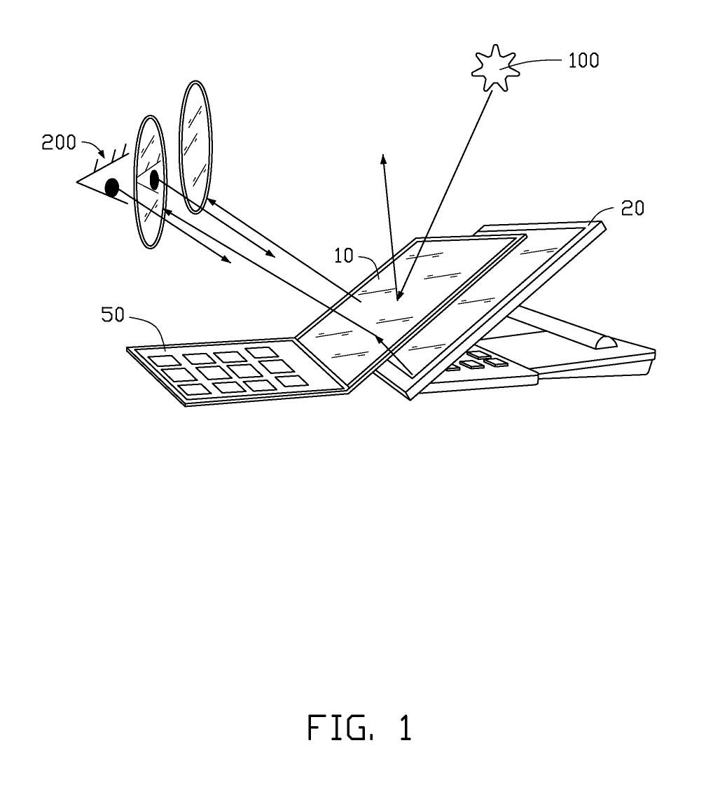

FIG. 1 illustrates an anti-glare cover 10 attached to a display panel 20 wherein incident light from a light source 100 cancan be reflected by the anti-glare cover 10 towards the light source 100, away from a viewer 200, and output light of the display panel 20 is refracted towards the viewer 200. In FIG. 1, the anti-glare cover 10 can be connected to an input device 50 wherein the input device 50 can be a keyboard, or a touch panel. The anti-glare cover 10 can be a film directly formed on the display panel 20. In addition to being anti-glare, the anti-glare cover 10 can provide privacy protections for the viewer 200 from by-standers who are not in line with view points of the display panel 20.

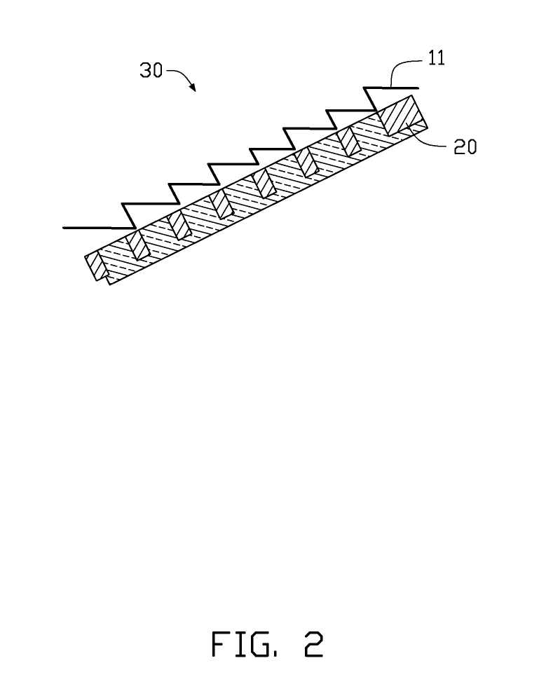

FIG. 2 illustrates an embodiment of an anti-glare display screen 30 wherein an anti-glare film 11 can be formed on the display panel 20. Parallel rows of microstructures 11 of the anti-glare film 11 can reflect incident light from the light source 100 back towards the light source 100, away from the viewer 200. FIG. 2 illustrates an embodiment wherein a cross section of each of the microstructures 11 can be an obtuse-angled triangle with an obtuse angle A facing away from the display panel. When in use, the anti-glare display screen 30 is positioned so that the obtuse angles A of the parallel rows of microstructures 11 face the incident light from the light source 100. In another embodiment, each of the microstructures 11 can be a tiled aspheric lens 13.

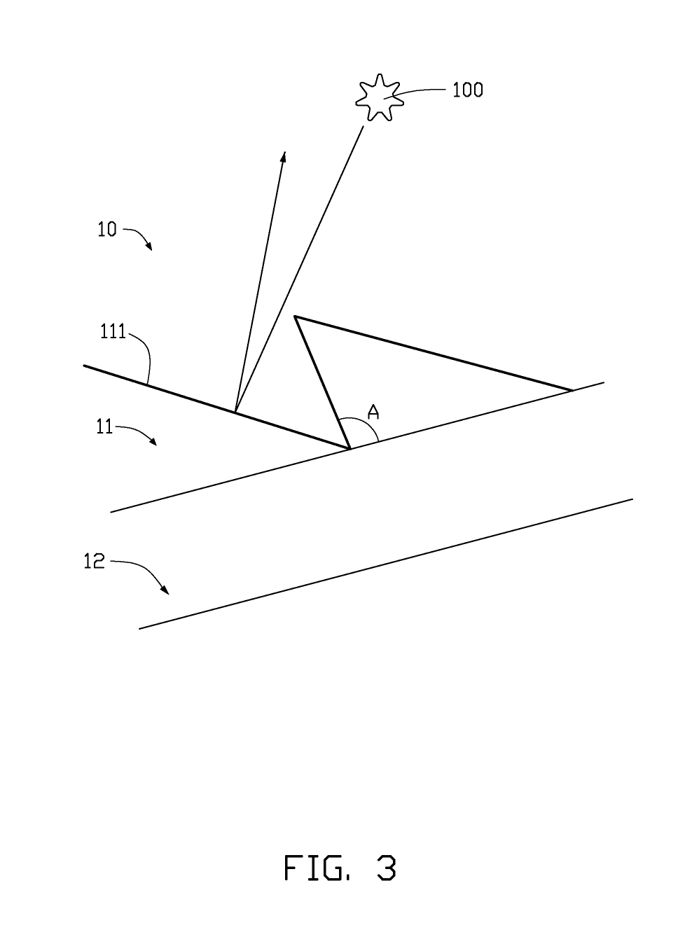

In detail, FIG. 3 illustrates one embodiment of the anti-glare cover 10 wherein the parallel rows of microstructures 11 are formed on a transparent substrate 12, an optical functional surface 111 of each of the microstructures 11 facing away from the transparent substrate 12. In one embodiment, a cross section of each of the microstructures 11 can be an obtuse-angled triangle with an obtuse angle A facing away from the substrate 12. When in use, the anti-glare display cover 10 is attached to the display panel 20, and positioned so that the obtuse angles A of the parallel rows of microstructures 11 face the incident light from the light source 100.

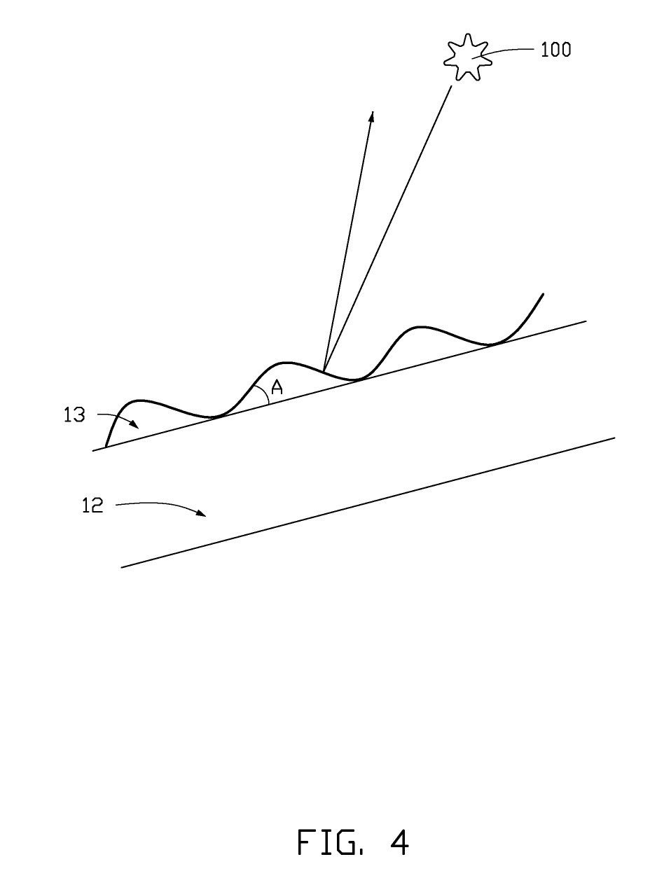

FIG. 4 illustrates another embodiment of the anti-glare cover 10 wherein each of the microstructures 11 can be a tiled aspheric lens 13. When in use, the anti-glare cover 10 is attached to the display panel 20, and positioned so that the parallel rows of microstructures 11 are tilted away from the incident light from the light source 100.

It is to be understood that the above-described embodiment is intended to illustrate rather than limit the disclosure. Variations can be made to the embodiment without departing from the spirit of the disclosure as claimed. The above-described embodiments are intended to illustrate the scope of the disclosure and not restricted to the scope of the disclosure.

It is also to be understood that the above description and the claims drawn to a method can include some indication in reference to certain steps. However, the indication used is only to be viewed for identification purposes and not as a suggestion as to an order for the steps.

1. An anti-glare cover for a display screen viewable by a user, comprising:
a substantially transparent film with a substantially flat first surface and a second surface having multiple indentations with a first angled surface and a second angled surface, the multiple indentations arranged in substantially parallel vertical rows;
wherein, the film is positionable over the display screen with the first film surface facing the display screen and the second film surface facing the user so that when the display screen is viewed by the user the first angled surface reflects incident light from a light source away from the user and towards the light source.

2. The anti-glare cover of claim 1, wherein the first angled surface and the second angled surface form an obtuse triangle on the film with the first angled surface opposite the obtuse angle of said triangle.

3. The anti-glare cover of claim 2, wherein the multiple indentations are parallel rows of microstructures.

4. The anti-glare cover of claim 3, wherein the anti-glare cover is configured to be connected to an input device.

5. The anti-glare cover of claim 4, wherein the input device is a keyboard.

6. The anti-glare cover of claim 4, wherein the input device is a touch panel.

7. An anti-glare cover for a display screen viewable by a user, comprising;
a substantially transparent film with a substantially flat first surface and a second surface having multiple parallel rows of tilted aspheric lens shaped protrusions;
wherein, the film is positionable over the display screen with the first film surface facing the display screen and the second film surface facing the user so that when the display screen is viewed by the user the tilted aspheric shaped protrusions reflect incident light from a light source away from the user and towards the light source.

8. The anti-glare cover of claim 7, wherein the tilted aspheric lens shaped protrusions are parallel rows of microstructures.

9. The anti-glare cover of claim 8, wherein the anti-glare cover is configured to be connected to an input device.

10. The anti-glare cover of claim 9, wherein the input device is a keyboard.

11. The anti-glare cover of claim 9, wherein the input device is a touch panel.

12. An anti-glare display screen viewable by a user comprising:
a display screen; and
an anti-glare film formed on the display screen, the anti-glare film comprising parallel rows of microstructures protruding away from the display screen and each configured for reflecting incident light from a light source away from the user and towards the light source.

13. The anti-glare display screen of claim 12, wherein a cross section of each of the microstructures is an obtuse-angled triangle with an obtuse angle facing away from the display screen.

14. The anti-glare display screen of claim 12, wherein each of the microstructures is a tilted aspheric lens.

15. The anti-glare cover of claim 2, wherein the obtuse angle of said triangle faces away from the display screen.

16. The anti-glare cover of claim 1, wherein the light source and the user are at a same side of the display screen.

17. The anti-glare cover of claim 7, wherein the light source and the user are at a same side of the display screen.

18. The anti-glare cover of claim 12, wherein the light source and the user are at a same side of the display screen.
